(19) United States
(12) Patent Application Publication
(10) Pub. No.: US 2026/0024296 A1
(43) Pub. Date: Jan. 22, 2026

(54) METHOD AND SYSTEM FOR GENERATING A THREE-DIMENSIONAL HAND MODEL FROM HETEROGENEOUS KEYPOINTS

(71) Applicant: Samsung Electronics Co., Ltd., Gyeonggi-do (KR)

(72) Inventors: Menghe ZHANG, San Diego, CA (US); Joonyeoup KIM, West Lafayette, IN (US); Yangwen LIANG, San Diego, CA (US); Shuangquan WANG, San Diego, CA (US); Kee-Bong SONG, San Diego, CA (US)

(21) Appl. No.: 19/272,593

(22) Filed: Jul. 17, 2025

Related U.S. Application Data
(60) Provisional application No. 63/673,449, filed on Jul. 19, 2024.

(51) Int. Cl. G06T 19/20; G06T 17/20

(52) U.S. Cl. CPC G06T 19/20; G06T 17/20; G06T 2210/32; G06T 2219/2004; G06T 2219/2016; G06T 2219/2021

(57) ABSTRACT

A method and a system for generating a 3D hand model are provided. The method includes: receiving heterogeneous hand keypoints collected from a plurality of tracking systems; performing a coarse optimization process to align the heterogeneous hand keypoints into an anatomical reference frame to produce unified hand keypoints; performing a fine optimization process to fit a hand mesh model to the unified hand keypoints; generating a 3D hand mesh using the hand mesh model fit to the unified hand keypoints; obtaining anatomical joint positions from the 3D hand mesh using a trained model; and outputting the 3D hand model including the 3D hand mesh and the anatomical joint positions.

### CROSS-REFERENCE TO RELATED APPLICATION

This application claims the priority benefit under 35 U.S.C. § 119(e) of U.S. Provisional Application No. 63/673,449, filed on Jul. 19, 2024, the disclosure of which is incorporated by reference in its entirety as if fully set forth herein.

### TECHNICAL FIELD

The disclosure generally relates to three-dimensional (3D) hand modeling. More particularly, the subject matter disclosed herein relates to improvements to generating 3D hand models from heterogeneous keypoint data collected by multiple tracking systems.

### SUMMARY

Hand tracking systems are used in applications such as virtual and augmented reality, gesture recognition, human-computer interaction, and animation. These systems estimate the positions of anatomical landmarks on the human hand, often using red, green and blue (RGB) cameras, depth sensors, or infrared-based motion tracking. However, different tracking systems produce keypoints that vary in format, coordinate systems, anatomical definitions, and accuracy, making it difficult to fuse data. Furthermore, hand modeling frameworks lack the ability to generate anatomically accurate and personalized 3D hand models from such heterogeneous input.

Some hand modeling frameworks apply hand pose estimation models trained on single-source datasets, or fit parametric hand meshes directly to keypoints generated by specific tracking systems. While such methods perform well under controlled conditions, they rely on uniform keypoint definitions and consistent coordinate systems.

To address these types of issues, systems and methods are described herein for generating anatomically accurate, personalized 3D hand models from heterogeneous hand keypoints collected across multiple tracking systems. The disclosed approach includes a coarse optimization process to align keypoints with varying formats and coordinate systems into a unified anatomical reference frame, followed by a fine optimization process that fits a deformable hand mesh model based on pose, shape, and wrist orientation parameters. A trained model, such as a neural network, is then used to derive anatomical joint positions from the reconstructed hand mesh. The resulting hand model includes a detailed surface mesh and anatomically consistent joint structure, enabling reliable use in gesture recognition, extended reality interaction, and animation.

In an embodiment, a method of generating a 3D hand model includes: receiving heterogeneous hand keypoints collected from a plurality of tracking systems; performing a coarse optimization process to align the heterogeneous hand keypoints into an anatomical reference frame to produce unified hand keypoints; performing a fine optimization process to fit a hand mesh model to the unified hand keypoints; generating a 3D hand mesh using the hand mesh model fit to the unified hand keypoints; obtaining anatomical joint positions from the 3D hand mesh using a trained model; and outputting the 3D hand model including the 3D hand mesh and the anatomical joint positions.

In an embodiment, a system for generating a 3D hand model includes: a memory storing instructions; and a processor configured to execute the instructions to: receive heterogeneous hand keypoints collected from a plurality of tracking systems; perform a coarse optimization process to align the heterogeneous hand keypoints into an anatomical reference frame to produce unified hand keypoints; perform a fine optimization process to fit a hand mesh model to the unified hand keypoints; generate a 3D hand mesh using the hand mesh model fit to the unified hand keypoints; obtain anatomical joint positions from the 3D hand mesh using a trained model; and output the 3D hand model including the 3D hand mesh and the anatomical joint positions.

In an embodiment, a non-transitory computer-readable medium storing instructions that, when executed by one or more processors, cause the one or more processors to perform a method of generating a 3D hand model, the method including: receiving heterogeneous hand keypoints collected from a plurality of tracking systems; performing a coarse optimization process to align the heterogeneous hand keypoints into an anatomical reference frame to produce unified hand keypoints; performing a fine optimization process to fit a hand mesh model to the unified hand keypoints; generating a 3D hand mesh using the hand mesh model fit to the unified hand keypoints; obtaining anatomical joint positions from the 3D hand mesh using a trained model; and outputting the 3D hand model including the 3D hand mesh and the anatomical joint positions.

### BRIEF DESCRIPTION OF THE DRAWING

In the following section, the aspects of the subject matter disclosed herein will be described with reference to exemplary embodiments illustrated in the figures, in which:

FIG. 1 is a method for generating a 3D hand model from heterogeneous keypoints, according to an embodiment;

FIG. 2 is a system architecture for implementing a hand model generation process, according to an embodiment;

FIG. 3 illustrates keypoint unification through coarse alignment of heterogeneous inputs, according to an embodiment;

FIG. 4 illustrates mesh reconstruction using fine optimization of a deformable hand model, according to an embodiment;

FIG. 5 illustrates joint derivation from a 3D hand mesh using a trained model, according to an embodiment;

FIG. 6 illustrates the fusion of MANO and NIMBLE joint representations into a unified 25-joint set, aligning statistical and anatomical landmarks, according to an embodiment.

FIG. 7 illustrates a neural network architecture configured to derive anatomical joint positions from mesh vertex inputs, according to an embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/of” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Unified hand keypoints” as used herein refer to a set of anatomical hand landmarks that have been transformed from their original heterogeneous formats and coordinate spaces into a shared anatomical reference frame. Some examples of “unified hand keypoints” are 3D joint positions derived from multiple tracking systems, such as Mediapipe, Ultraleap, and HoloLens, after undergoing coarse optimization including translation, rotation, and scaling to ensure anatomical consistency and alignment across these sources.

“Rigid-body transformation” as used herein refers to an operation that preserves relative distances and angles between points in a coordinate space while altering their global position or orientation. Some examples of “rigid-body transformation” are 3D translation, rotation, and uniform scaling operations applied to keypoint sets to align them within a common (e.g., unified) anatomical reference frame. “Translation” as used herein refers to a rigid-body transformation that shifts points in a coordinate space by a fixed vector without altering their relative positions or orientations. Some examples of “translation” are shifting a set of hand keypoints along the X, Y, or Z axis to align the wrist with a canonical origin. “Rotation” as used herein refers to a rigid-body transformation that pivots points in a coordinate space around a fixed axis while preserving their relative distances and angles. Some examples of “rotation” are rotating wrist-related keypoint sets so they conform to a canonical hand pose during coarse optimization. “Scaling” as used herein refers to a geometric transformation that enlarges or reduces the size of a coordinate structure relative to a fixed point while preserving its overall shape. Some examples of “scaling” are adjusting the spatial extent of hand keypoints to normalize hand size across different tracking systems.

“Pose parameters” as used herein refer to a set of values that encode the relative orientations or rotations of the joints in a hand model representing finger flexion, abduction, or wrist angle. Some examples of “pose parameters” are representations used to define the rotation of each joint in a deformable mesh model such as MANO. “Shape parameters” as used herein refer to a set of values that define the anatomical structure of a hand. Some examples of “shape parameters” are vectors that control hand width, finger length, or palm curvature in a parametric mesh model. “Wrist orientation parameters” as used herein refer to values that represent the global rotation of the wrist relative to a reference frame. Some examples of “wrist orientation parameters” include rotation matrices that are optimized during the coarse or fine alignment stages to account for misalignment between different coordinate systems and the wrist axis.

“Neural network” as used herein refers to a computational model composed of interconnected layers of nodes where each node applies a learned function to its input and passes the result to subsequent layers. Neural networks may be trained on labeled data to approximate mappings between inputs and outputs. Some examples of “neural networks” include convolutional networks for image recognition and fully connected networks for regression tasks such as joint position estimation from mesh data.

“Multi-layer perceptron” (MLP) as used herein refers to a type of neural network consisting of fully connected layers, where each layer applies a linear transformation followed by a non-linear activation function. Some examples of “MLPs” include networks that accept 3D hand mesh vertex positions as input and output anatomical joint coordinates, using fixed side layers with activation functions such as Gaussian Error Linear Unit (GELU) and normalization techniques such as batch normalization.

According to an embodiment of the disclosure, there is provided a system and method for generating anatomically accurate and personalized 3D hand models from heterogeneous keypoint data collected by multiple tracking systems. Tracking systems, such as Mediapipe, Ultraleap, and HoloLens, each output hand keypoints with differing formats, coordinate systems, and anatomical conventions, making unified processing difficult. The disclosure addresses this by performing a coarse optimization process that aligns heterogeneous keypoints into a common anatomical reference frame using rigid transformations such as translation, rotation, and scaling. This unified keypoint structure enables downstream processes to interpret hand pose and geometry in a consistent way, regardless of the source device.

Following coarse alignment, the system performs a fine optimization process that fits a deformable hand mesh model to the unified keypoints using pose, shape, and wrist orientation parameters. From this fitted mesh, a trained neural network derives anatomical joint positions by analyzing the mesh's vertex geometry. The output is a complete 3D hand model that includes a high-resolution surface mesh and joint positions, suitable for real-time applications such as gesture recognition, animation, virtual interaction, and biomechanical feedback.

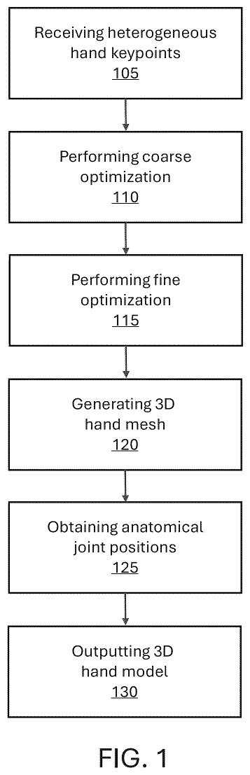

FIG. 1 is a method for generating a 3D hand model from heterogeneous keypoints, according to an embodiment.

In step 105, heterogeneous hand keypoints collected from a plurality of tracking systems are received. These tracking systems may include camera-based, infrared-based, or mixed-reality sensors, such as Mediapipe, Ultraleap, or HoloLens. Each system may produce keypoints in different quantities, formats, and coordinate definitions, resulting in heterogeneous inputs. The hand keypoints represent anatomical features of the hand, including joints, fingertips, and wrist positions, and may be received as structured data (e.g., arrays or tensors) in real time or from a stored data source. This step forms the input stage of the method, providing the raw spatial data used for downstream alignment and mesh reconstruction.

In step 110, a coarse optimization process is performed to align the heterogeneous hand keypoints into a common anatomical reference frame. This process compensates for differences in coordinate systems, orientation, and keypoint structure that arise from the use of multiple tracking systems. The coarse optimization may apply one or more global transformations, including translation, rotation, and uniform scaling, based on anatomical anchors such as the wrist or palm center. These transformations normalize the spatial positioning of the keypoints, ensuring that data collected from different devices can be processed consistently. The resulting unified hand keypoints serve as the basis for downstream fine optimization and mesh generation.

In step 115, a fine optimization process is performed to fit a deformable hand mesh model to the unified hand keypoints produced during the coarse optimization stage. The fine optimization estimates a set of parameters for the hand model, including a pose parameter vector, a shape parameter vector, and a global wrist rotation matrix. These parameters are refined using gradient-based optimization techniques, such as stochastic gradient descent or Adam, to minimize a loss function based on the distance between the unified hand keypoints and the corresponding joint locations derived from the mesh. Additional regularization terms may be applied to preserve anatomical plausibility and mesh smoothness. The result is a personalized hand mesh model that accurately reflects an individual's hand geometry and articulation.

In step 120, the system generates a 3D hand mesh using the hand mesh model fit to the unified hand keypoints during fine optimization. The 3D hand mesh is constructed by applying the optimized pose and shape parameters to a parametric hand model, such as MANO or a similar deformable mesh framework. This step produces a surface representation of the user's hand, where each vertex in the 3D hand mesh reflects anatomically correct geometry based on the personalized optimization process. The resulting 3D hand mesh captures the size, proportions, and pose of the individual's hand and serves as the basis for subsequent joint derivation and rendering operations.

In step 125, the system obtains anatomical joint positions from the 3D hand mesh using a trained model. The trained model, which may comprise a neural network such as an MLP, receives the mesh vertex data as input and outputs a set of 3D joint coordinates corresponding to anatomical landmarks of the hand. These joint positions may include the wrist, metacarpophalangeal (MCP) joints, interphalangeal joints, and fingertips. The model is trained using ground-truth joint data derived from anatomically accurate meshes and is capable of mapping complex geometric variations in the mesh to biologically meaningful joint outputs. This process enables the derivation of a skeletal structure from the mesh representation.

In step 130, the system outputs the complete 3D hand model, which includes both the 3D hand mesh and the anatomical joint positions derived from the mesh. The output may be formatted for use in downstream applications such as gesture recognition, animation rigging, extended reality (XR) interaction, or biomechanical analysis. The combined mesh and joint structure represents a personalized, anatomically accurate model of an individual's hand that can be rendered, manipulated, or used as an input to higher-level software systems. The final output may be delivered to a rendering engine, stored for later use, or streamed to an external device or cloud service, depending on system configuration.

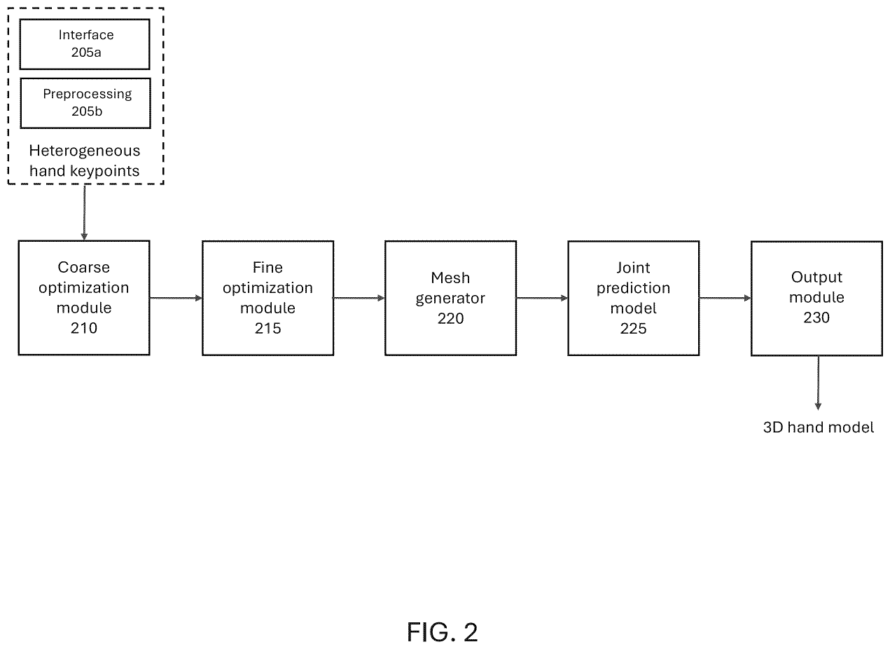

FIG. 2 is a system architecture for implementing a hand model generation process, according to an embodiment. The system includes a set of components that may be distributed across one or more processing units, including central processing units (CPUs), graphics processing units (GPUs), neural processing units (NPUs), and associated memory devices. In particular, the system's components include a coarse optimization module 210, a fine optimization module 215, a mesh generator 220, a joint prediction model 225 and an output module 230. The system may also include a tracking system interface module 205a as well as a preprocessing and normalization module 205b at the input side of the coarse optimization module 210. Each of the components of this system may be implemented in hardware as an electronic circuit.

The tracking system interface module 205a is configured to receive heterogeneous hand keypoints from a plurality of tracking systems. These tracking systems may include RGB-based computer vision pipelines, depth sensors, infrared trackers, or mixed-reality devices such as Mediapipe, Ultraleap, or HoloLens. The input data may vary in resolution, format, and coordinate system.

The preprocessing and normalization module 205b, executed on a CPU or co-processor, standardizes the incoming keypoint data. This may include unit normalization, coordinate transformation, padding or interpolation of missing values, and format conversion into a consistent data structure.

The coarse optimization module 210, implemented on a CPU or GPU, performs global alignment of the heterogeneous hand keypoints into a shared anatomical reference frame. The alignment process may include rigid-body transformations such as translation, rotation, and scaling, anchored to anatomical landmarks like the wrist and palm center. The output is a unified representation of the hand keypoints suitable for mesh fitting.

The fine optimization module 215, executed on a GPU or neural processor, refines a deformable hand mesh model using optimization techniques based on pose parameters, shape parameters, and wrist orientation. The fine optimization module 215 minimizes data-fitting loss between the hand mesh and unified keypoints, and may include regularization terms for mesh smoothness and anatomical plausibility.

The mesh generator 220 applies the optimized parameters to a parametric hand model (e.g., MANO) to construct a high-resolution 3D surface mesh of the hand. This module may share resources with the fine optimization module.

The joint prediction model 225, implemented as a trained neural network, receives the mesh vertex data and outputs anatomical joint positions. The joint prediction model 225 may be an MLP executed on a GPU, NPU, or other artificial intelligence (AI) accelerator. The joint positions represent landmarks such as MCP, proximal interphalangeal (PIP), distal interphalangeal (DIP), and fingertip locations.

The output module 230 delivers the final 3D hand model, including both the reconstructed mesh and anatomical joint structure, to one or more downstream applications. The output may be rendered, stored, or streamed, depending on system requirements.

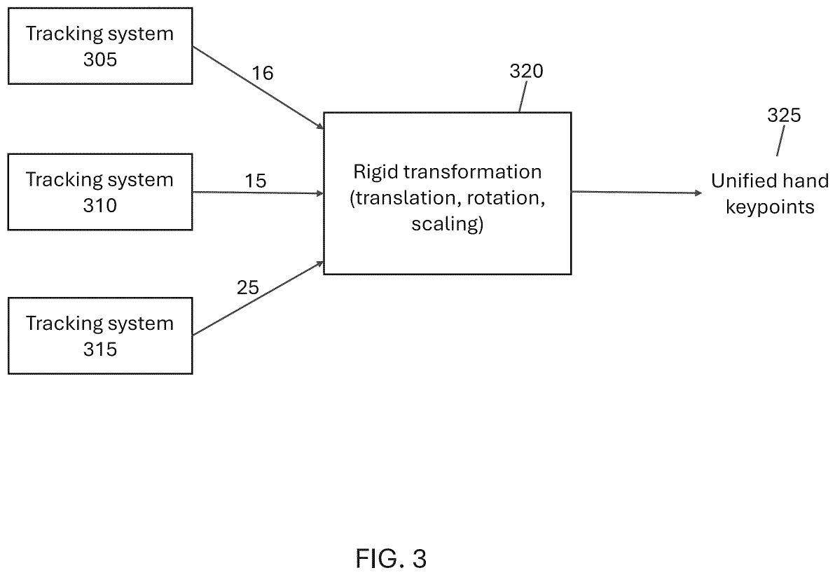

FIG. 3 illustrates keypoint unification through coarse alignment of heterogeneous inputs, according to an embodiment. A plurality of tracking systems, such as a first tracking system 305, a second tracking system 310, and a third tracking system 315, may generate hand keypoint data using differing sensor modalities, such as RGB cameras, infrared depth sensors, or structured light systems. Each tracking system may output a distinct set of keypoints, such as 16, 15, or 25 landmarks, depending on their underlying detection algorithms and anatomical models.

The heterogeneous hand keypoints differ not only in quantity and anatomical layout but also in their coordinate spaces and naming conventions. For example, some systems report keypoints in camera-relative coordinates, while others use device-centric or normalized screen-space coordinates. These inconsistencies prevent direct fusion or modeling.

The raw keypoints from each tracking system are transmitted to a coarse optimization module 320, which performs a global alignment process to normalize the keypoints into a shared anatomical reference frame. The coarse optimization module 320 in FIG. 3 corresponds to the coarse optimization module 210 of FIG. 2. An embodiment of the disclosure employs a two-stage optimization approach, where the first stage (shown in FIG. 3) applies a coarse rigid alignment based on anchor points such as the wrist and palm center. A goal of this process is to perform a transformation that brings the disparate input keypoints into rough anatomical agreement before any mesh fitting or personalization takes place.

An embodiment of the disclosure uses an alignment criterion that minimizes distance between estimated keypoints and a canonical (e.g., standard) hand skeleton, tolerating differences across devices and datasets. In one example, the alignment may use Procrustes analysis or an energy-based function that evaluates wrist-relative and palm-relative distances among joint sets. The process may also incorporate scaling factors to adjust for variations in hand size or camera depth.

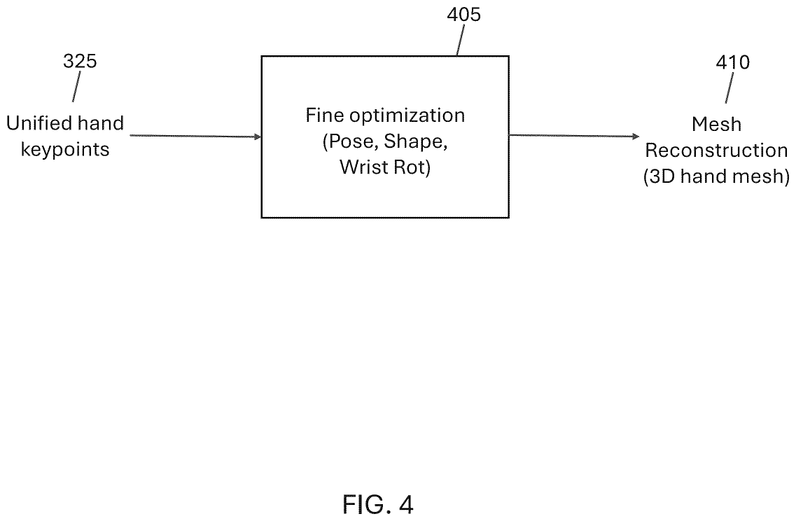

The output of the coarse optimization module 320 is a unified set of hand keypoints 325, which is an intermediate hand representation that is anatomically consistent across input modalities. The unified hand keypoints 325 are used as input to the fine optimization process (described in FIG. 4), where a personalized mesh model is constructed.

FIG. 4 illustrates mesh reconstruction using fine optimization of a deformable hand model, according to an embodiment. After the coarse optimization module 320 has generated the unified hand keypoints 325, those keypoints are forwarded to a fine optimization module 405, which estimates a parametric hand mesh by refining pose and shape parameters. The fine optimization module 405 outputs optimized parameters θ (pose), β (shape), and a R_{w} (wrist orientation), which are passed to a mesh generator 410. In FIG. 4, the fine optimization module 405 corresponds to the fine optimization module 215 of FIG. 2, and the mesh generator 410 corresponds to the mesh generator 220 of FIG. 2.

The fine optimization module 405 minimizes keypoint alignment loss, which is defined in the equation below.

$${E}_{key} = {\sum }_{i}^{N} {\vert \vert {k}_{i} - {J}_{i} ( θ , β , {R}_{w} ) \vert \vert}^{2}$$

In the above equation, where kᵢ are the input keypoints, (i∈[1, . . . , N]) and Jᵢ(θ,β,R_{w}) are the derived joints from the hand mesh. This alignment ensures that the generated mesh conforms to observed anatomical landmarks.

The optimization proceeds in two stages. In the coarse stage, an initial hand pose θ̅ and mean shape p are employed, and the system optimizes for the wrist rotation R_{w}. In the fine stage, two optimizers are employed: one refines the pose and shape parameters (0,3), and another fine-tunes the wrist rotation R_{w}, using the Adam optimizer for gradient-based convergence.

To ensure anatomical plausibility and geometric smoothness, the system introduces regularization terms into the optimization such that the total alignment error adds up as defined in the equation below.

$$E = {E}_{key} + {λ}_{reg} {E}_{reg} + {λ}_{smooth} {E}_{smooth}$$

In this equation, E_{reg} (e.g., deformation regularization loss) penalizes excessive deformation, Eₛₘₒₒₜₕ (e.g., surface smoothness loss) enforces smooth transitions between neighboring vertices, and λ_{reg} and λₛₘₒₒₜₕ represent the weights of the corresponding errors (deformation regularization error and surface smoothness error respectively) that contribute to the total error. λ_{reg} may be 0.1 and λₛₘₒₒₜₕ may be 0.01. E_{reg} and Eₛₘₒₒₜₕ are represented by the following equations.

$${E}_{reg} = {\vert β \vert}^{2} + {\vert θ \vert}^{2}$$

$${E}_{smooth} = {\sum }_{i} {\sum }_{j ∈ N ( i )} {\vert {v}_{i} - {v}_{j} \vert}^{2}$$

In Eₛₘₒₒₜₕ, vᵢ and vⱼ are adjacent mesh vertices, and N(i) denotes the set of neighboring vertices of vertex i.

Additionally, in an embodiment where the high-resolution geometry is generated using a NIMBLE model, the system fits a lower-resolution MANO model to the NIMBLE-derived mesh via the following optimization:

$${θ}_{m}^{*} , {β}_{m}^{*} = arg {min}_{{θ}_{m} , {β}_{m}} {\vert {M}_{v} - M ( {θ}_{m} , {β}_{m} ) \vert}^{2} + {λ}_{θ} {ℛ}_{θ} ( {θ}_{m} ) + {λ}_{β} {ℛ}_{β} ( {β}_{m} )$$

In the aforementioned optimization, M, represents the mesh vertices sampled from the NIMBLE representation, M(θₘ,βₘ) is the MANO mesh generated using pose and shape parameters, and [symbol] _{θ}, [symbol] _{β} are regularization terms to constrain parameter ranges.

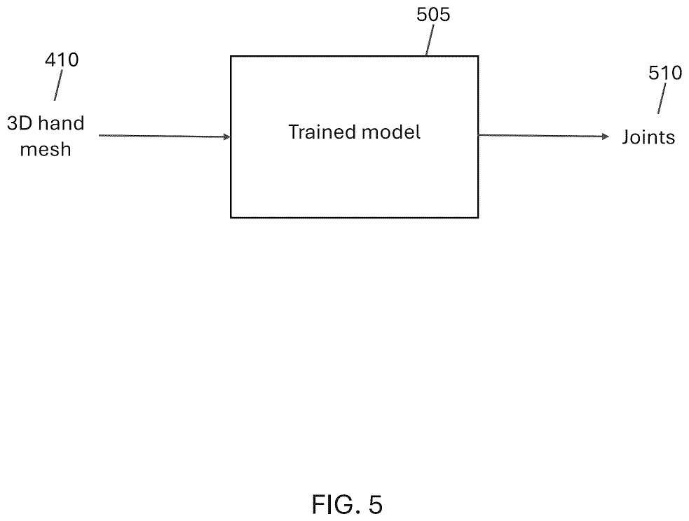

The output of the mesh generator 410 is a fully reconstructed, personalized 3D hand mesh model that accurately reflects the individual's hand geometry and articulation. This 3D hand mesh model is then passed to the joint derivation process described in FIG. 5.

FIG. 5 illustrates joint derivation from a 3D hand mesh using a trained model, according to an embodiment. This step occurs after the fine optimization and mesh reconstruction stage and may be performed by the joint prediction model 225 of FIG. 2.

As shown, the system receives as input a 3D hand mesh 410, generated by the pipeline described in FIG. 4. The 3D hand mesh 410 comprises a set of 3D vertices representing the external geometry of the individual's hand, including pose and structural detail captured through fine optimization.

The 3D hand mesh 410 is passed to a trained model 505, which is implemented using a machine-learned architecture such as MLP. The model 505 may be trained using ground-truth anatomical joint positions paired with mesh data and is configured to learn a mapping from mesh vertex space to a skeletal representation. In one embodiment, the MLP accepts as input a 778×3 matrix of mesh vertices (e.g., a MANO mesh) and outputs a 25×3 matrix of joint coordinates (e.g., NIMBLE-like hand joints).

The trained model 505 may apply multiple fully connected layers interleaved with batch normalization and non-linear activations (e.g., GELU) to learn spatial dependencies between surface geometry and internal joint locations. This allows the network to infer positions of anatomical landmarks such as the wrist, MCP joints, PIP joints, and fingertips, even when some input regions may be occluded or noisy.

The output of the trained model 505 is a structured set of 3D anatomical joint positions 510, which are expressed in the same coordinate frame as the input 3D hand mesh 410. These joints are consistent with standard human hand anatomy and allow the reconstructed hand model to be used for downstream applications such as gesture recognition, kinematic modeling, animation rigging, and biomechanical analysis.

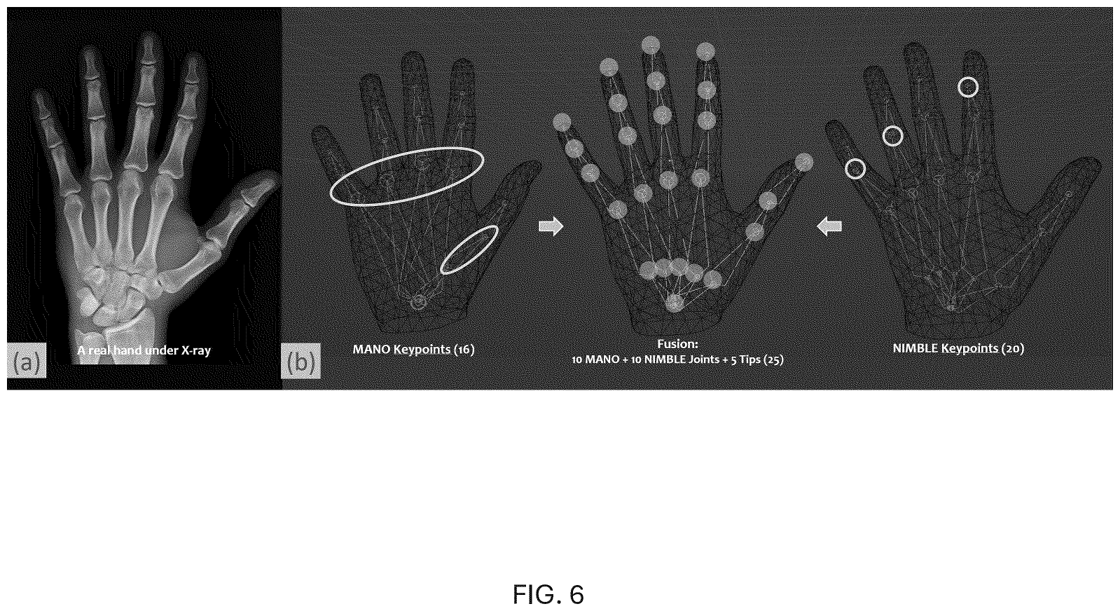

FIG. 6 illustrates the fusion of MANO and NIMBLE joint representations into a unified 25-joint set, aligning statistical and anatomical landmarks, according to an embodiment. Panel (a) shows an X-ray image of a real human hand, depicting the skeletal structure and anatomical joint positions that serve as ground truth references. Panel (b), the leftmost image, shows 16 parametric keypoints defined by the MANO model, which are optimized for surface pose estimation but do not fully align with anatomical joint centers. Panel (b), the middle image, shows the result of a fusion process in which a subset of MANO joints (10), a subset of NIMBLE anatomical joints (10), and 5 fingertip locations are combined to form a unified set of 25 joints, in accordance with an embodiment of the present disclosure. This fusion step enables a consistent mapping between statistical mesh-based joints and anatomical references. Panel (b), the rightmost image, shows the 20 anatomical keypoints defined by the NIMBLE model, which accurately reflect skeletal joint centers but lack some surface-level articulation detail. The fusion process according to an embodiment of the present disclosure, depicted in the middle image, supports downstream tasks such as joint prediction and rendering.

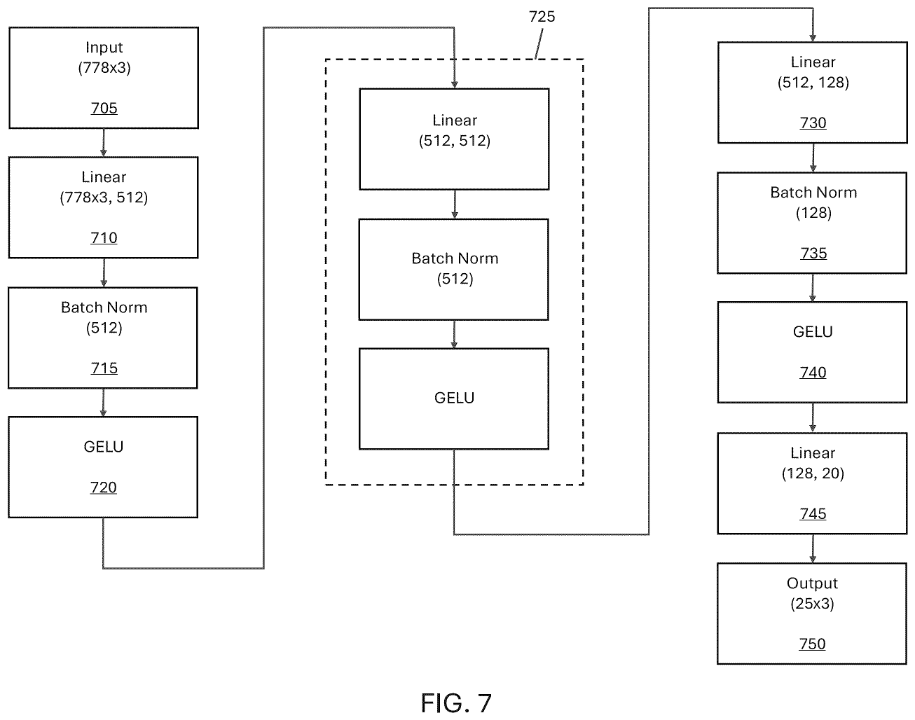

FIG. 7 illustrates a neural network architecture configured to derive anatomical joint positions from mesh vertex inputs, according to an embodiment. This architecture represents the structure of the trained model 505 shown in FIG. 5 and is implemented using an MLP that maps 3D surface geometry data to anatomical joint positions.

The input to the model 505 is a mesh vertex array 705, which consists of 778 vertices, each represented by 3D coordinates (x, y, z), yielding a 778×3 input tensor. This array encodes the full surface geometry of the reconstructed 3D hand mesh 410.

The input tensor is passed through an initial linear projection layer 710, which maps the input into a 512-dimensional feature space. This is followed by a batch normalization layer 715 and a GELU activation layer 720, which provide normalization and non-linearity to the learned representations.

A processing block 725, repeated multiple times (e.g., four layers deep), further transforms the feature space using a sequence of: fully connected layers, batch normalization and GELU activations. This repeated structure enables the model 505 to capture spatial relationships between mesh vertices and anatomical joint positions.

After deep processing, the network includes a compression layer 730 that reduces the feature dimension to 128. This is followed by another round of batch normalization 735 and GELU activation 740, refining the signal before final prediction.

The final output is produced by an output linear layer 745, which projects the compressed features to a structured joint output 750. The output 750 is a 25×3 matrix, representing the 3D coordinates of 25 anatomical joints, including landmarks such as the wrist, MCP joints, PIP joints, DIP joints, and fingertips.

The prediction model 505 may be trained using supervised learning with labeled mesh-joint pairs and may include regularization strategies to promote anatomical plausibility and positional stability. The output joints 750 are used in combination with the reconstructed 3D hand mesh 410 to form the complete 3D hand model. The completed 3D hand model may then be used in a downstream application that involves re-animating personalized hand meshes using corresponding skeleton rigs or physically-based rendering of high-fidelity hand images and videos.

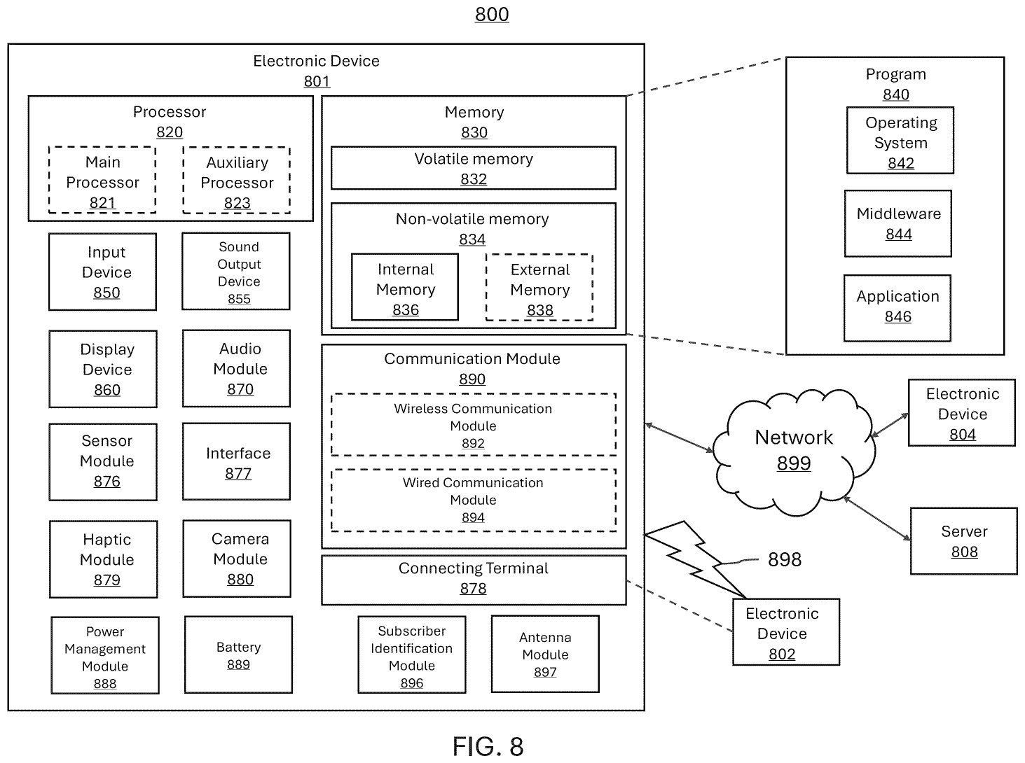

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

As shown in FIG. 8, the method and system for generating a 3D hand model as described with reference to FIGS. 1-7 may be implemented using the electronic device 801. The method steps, including receiving heterogeneous hand keypoints, performing coarse and fine optimization, generating a 3D hand mesh, and deriving anatomical joint positions, may be executed by the processor 820 based on instructions stored in memory 830. In embodiments where the system of FIG. 2 is implemented in software, each processing module (e.g., coarse optimization module 210, fine optimization module 215) may correspond to a distinct set of instructions executed on the electronic device 801.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of generating a three-dimensional (3D) hand model, comprising:
receiving heterogeneous hand keypoints collected from a plurality of tracking systems;
performing a coarse optimization process to align the heterogeneous hand keypoints into an anatomical reference frame to produce unified hand keypoints;
performing a fine optimization process to fit a hand mesh model to the unified hand keypoints;
generating a 3D hand mesh using the hand mesh model fit to the unified hand keypoints;
obtaining anatomical joint positions from the 3D hand mesh using a trained model; and
outputting the 3D hand model including the 3D hand mesh and the anatomical joint positions.

2. The method of claim 1, wherein the heterogeneous hand keypoints differ in format and coordinate definition.

3. The method of claim 1, wherein the coarse optimization process includes aligning the heterogeneous hand keypoints based on anatomical reference points.

4. The method of claim 1, wherein the coarse optimization process comprises applying a rigid-body transformation including at least one of translation, rotation, or scaling.

5. The method of claim 1, wherein the fine optimization process includes refining at least a pose parameter, a shape parameter, or a wrist parameter of the hand mesh model.

6. The method of claim 1, wherein the fine optimization process minimizes a keypoint alignment loss based on a distance between the unified hand keypoints and the anatomical joint positions.

7. The method of claim 6, wherein the fine optimization process further minimizes a total loss including the keypoint alignment loss, a deformation regularization loss, and a surface smoothness loss.

8. The method of claim 1, wherein generating the 3D hand mesh using the hand mesh model includes applying a pose parameter vector and a shape parameter vector to a parametric mesh model to produce a deformable hand surface.

9. The method of claim 1, wherein the trained model includes a neural network configured to receive mesh vertex positions as input and output the anatomical joint positions.

10. The method of claim 9, wherein the neural network includes a multi-layer perceptron.

11. The method of claim 9, wherein the trained model is trained using anatomical joint positions derived from an anatomical hand mesh.

12. The method of claim 1, wherein the 3D hand model output includes a mesh and joint structure that are anatomically consistent across the plurality of tracking systems.

13. A system for generating a three-dimensional (3D) hand model, comprising:
a memory storing instructions; and
a processor configured to execute the instructions to:
receive heterogeneous hand keypoints collected from a plurality of tracking systems;
perform a coarse optimization process to align the heterogeneous hand keypoints into an anatomical reference frame to produce unified hand keypoints;
perform a fine optimization process to fit a hand mesh model to the unified hand keypoints;
generate a 3D hand mesh using the hand mesh model fit to the unified hand keypoints;
obtain anatomical joint positions from the 3D hand mesh using a trained model; and
output the 3D hand model including the 3D hand mesh and the anatomical joint positions.

14. The system of claim 13, wherein the heterogeneous hand keypoints differ in format and coordinate definition.

15. The system of claim 13, wherein the processor is configured to align the heterogeneous hand keypoints based on anatomical reference points including a wrist location and a palm center.

16. The system of claim 13, wherein the processor is configured to refine at least a pose parameter, a shape parameter, or a wrist orientation parameter of the hand mesh model during the fine optimization process.

17. The system of claim 13, wherein the trained model comprises a neural network configured to receive mesh vertex positions as input and output the anatomical joint positions.

18. The system of claim 17, wherein the neural network includes a multi-layer perceptron.

19. The system of claim 13, wherein the 3D hand model output includes a mesh and joint structure that are anatomically consistent across the plurality of tracking systems.

20. A non-transitory computer-readable medium storing instructions that, when executed by one or more processors, cause the one or more processors to perform a method of generating a three-dimensional (3D) hand model, the method comprising:
receiving heterogeneous hand keypoints collected from a plurality of tracking systems;
performing a coarse optimization process to align the heterogeneous hand keypoints into an anatomical reference frame to produce unified hand keypoints;
performing a fine optimization process to fit a hand mesh model to the unified hand keypoints;
generating a 3D hand mesh using the hand mesh model fit to the unified hand keypoints;
obtaining anatomical joint positions from the 3D hand mesh using a trained model; and
outputting the 3D hand model including the 3D hand mesh and the anatomical joint positions.
